(19) United States
(12) Patent Application Publication
(10) Pub. No.: US 2019/0301882 A1
(43) Pub. Date: Oct. 3, 2019

(54) Method, Device and Computer-Readable Storage Medium Comprising Instructions for Providing Content for Display to an Occupant Of a Motor Vehicle

(71) Applicant: Volkswagen Aktiengesellschaft, Wolfsburg (DE)

(72) Inventors: Bernd Rössler, Sassenburg (DE); Christian Bruns, Braunschweig (DE); Julia Kwasny, Wolfsburg (DE)

(73) Assignee: Volkswagen Aktiengesellschaft, Wolfsburg (DE)

(21) Appl. No.: 16/366,030

(22) Filed: Mar. 27, 2019

(30) Foreign Application Priority Data
Mar. 29, 2018 (DE) 10 2018 204 941.6

(51) Int. Cl. G01C 21/36; G06K 9/00; G06F 3/01

(52) U.S. Cl. CPC G01C 21/367; G06F 3/013; G06K 9/00845; G01C 21/3676

(57) ABSTRACT

A method, a device and a computer-readable storage medium comprising instructions for providing content for display to an occupant of a motor vehicle. In a first step, information on the occupant is received. In addition, information on a route of travel of the motor vehicle is received. On the basis of the information received, content to be displayed to the occupant is then determined. Optionally, information on a viewing direction of the occupant of the motor vehicle can also be received. This information on the viewing direction can be used to designate a display device for displaying the content to be displayed. Finally, the content to be displayed is transmitted to at least one display device on the route of travel of the motor vehicle.

### CROSS-REFERENCE TO RELATED APPLICATIONS

This application claims priority to German Patent Application No. DE 10 2018 204 941.6, filed on Mar. 29, 2018 with the German Patent and Trademark Office. The contents of the aforesaid German Patent Application are incorporated herein in their entireties for all purposes.

### TECHNICAL FIELD

The present invention relates to a method, a device and a computer-readable storage medium comprising instructions for providing content for display to an occupant of a motor vehicle. The invention further relates to a motor vehicle that can be used in conjunction with the method or device.

### BACKGROUND

Although traditional outdoor advertising has predominantly been displayed on (illuminated) poster boards, billboards or advertising columns, for a number of years, digital advertising media have increasingly been making inroads into outdoor advertisement. In the case of digital advertising media, display devices are used to reproduce alternating images, animations or video sequences on the basis of digital data. Examples of display devices used include large screens (videoboards) or projectors for projecting content onto building walls or special projection surfaces. The possibility of individually adapting the content displayed raises the question of how to determine which content should be displayed at a particular time.

Against this backdrop, EP 2 219 162 A1 describes a method for personalized advertising according to the interests of a user of a mobile electronic device. The mobile electronic device transmits a requirement profile of an end user to a data server via a wireless data network. Furthermore, the position data of the device are transmitted to the server. In addition, offer profiles of advertisers are stored on the server. If the end user draws close to an advertising screen, the server determines the correlation between the requirement profile and the offer profiles. An advertisement that best corresponds to the requirement profile of the end user is then displayed on the advertising screen.

DE 10 2012 213 466 A1 describes a method for monitoring a vehicle occupant. A plurality of objects in the vehicle's surroundings are detected by means of an environment detection apparatus. Furthermore, a viewing direction of the vehicle occupant is detected by means of a view detection apparatus. The detected viewing direction is then automatically assigned to one of the detected objects by means of an assignment apparatus in order to then determine which object of the plurality of objects the vehicle occupant has looked at. This information may be transmitted to a cloud server.

### SUMMARY

An object of the invention is to provide solutions for providing content for display to an occupant of a motor vehicle, which solutions enable content that is of greater relevance to the occupant to be displayed.

This object is solved by a method, by a computer-readable storage medium comprising instructions, by a device, and by a motor vehicle having the features of the independent claims. Some embodiments of the present aspect are the subject matter of the dependent claims and the following description.

In a first aspect, a method for providing content for display to an occupant of a motor vehicle comprises the following steps:
receiving information on the occupant;
receiving information on a route of travel of the motor vehicle;
determining content to be displayed to the occupant; and
transmitting the content to be displayed to at least one display device on the route of travel of the motor vehicle.

In a second aspect, a computer-readable storage medium contains instructions that, when executed by a computer, cause the computer to execute the following steps for providing content for display to an occupant of a motor vehicle:
receiving information on the occupant;
receiving information on a route of travel of the motor vehicle;
determining content to be displayed to the occupant; and
transmitting the content to be displayed to at least one display device on the route of travel of the motor vehicle.

The term computer is to be interpreted broadly. In particular, the computer also comprises work stations, distributed systems and other processor-based data processing devices.

According to another aspect, a device for providing content for display to an occupant of a motor vehicle has:
a reception module for receiving information on the occupant and for receiving information on a route of travel of the motor vehicle;
an evaluation module for determining content to be displayed to the occupant; and
a transmission module for transmitting the content to be displayed to at least one display device on the route of travel of the motor vehicle.

### BRIEF DESCRIPTION OF THE DRAWINGS

The invention is now explained below based on exemplary embodiments with reference to the drawings.

FIG. 1 schematically shows a method for providing content for display to an occupant of a motor vehicle;

FIG. 2 shows a first embodiment of a device for providing content for display to an occupant of a motor vehicle;

FIG. 3 shows a second embodiment of a device for providing content for display to an occupant of a motor vehicle;

FIG. 4 schematically shows a motor vehicle which can be used in conjunction with a solution according to an embodiment;

FIG. 5 schematically shows a system diagram of a first implementation of the explained solution; and

FIG. 6 schematically shows a system diagram of a second implementation of the explained solution.

### DETAILED DESCRIPTION

Vehicle manufacturers are increasingly offering customer portals in which customers can register themselves and their vehicles as well as enter additional information, if applicable. By means of customer portals of this kind, extensive knowledge on characteristics and interests of the customers can be gathered. This knowledge can be used in various ways, as far as the customer agrees to the use of the data. According to this explanation, the knowledge on the customer, or vehicle occupants, and information on the route of travel, from which positions of the motor vehicle can be predicted, are combined in order to display content in a targeted manner. The content may in particular include advertisements that can be shown in a manner adapted to the customer at the right place and at the right time. The available information on the route of travel makes it possible to transmit the content to be displayed to the corresponding display devices at an early stage. This ensures that the data required for the display of the desired content are available in good time. Large volumes of data often have to be transmitted, above all for the display of video sequences, for which there may, under certain circumstances, not be enough time without prediction of the positions of the motor vehicle.

According to some embodiments, the content to be displayed is determined on the basis of information on two or more occupants. Alternatively or additionally and in further embodiments, the content to be displayed may be determined on the basis of information on routes of travel of two or more motor vehicles. There is often more than one occupant in a motor vehicle, and two or more motor vehicles often pass a display device at more or less the same time. In such cases, it may be sensible to adapt the content to be displayed to several or even all occupants involved. For this purpose, it may for example be determined whether the occupants share interests or other characteristics. In the presence of common interests, the content to be displayed may be adapted directly to these common interests. If, for example, it is known that all occupants involved are interested in sport, the content to be displayed may advertise an upcoming sporting event or a supplier of sports equipment. If there are commonalities with regard to other characteristics, e.g. age, gender, income, personal situation, etc., content to be displayed may be determined for the target group sharing that particular characteristic. An advertiser can for example establish that the target group of their advertisement is predominantly women. In this case, the advertisement may be displayed if the occupants involved are only or primarily women. Alternatively, the content to be displayed may be determined in consideration of different priorities. For example, the drivers may be considered before other vehicle occupants. Similarly, the suppliers of the content to be displayed may establish a hierarchy of content or themselves be prioritized in different ways by the operators of the display device.

In some embodiments, the information on the route of travel of a motor vehicle is provided by a navigation apparatus of the motor vehicle or deduced from a journey profile of the motor vehicle or occupant of the motor vehicle. The provision of information by means of the navigation apparatus has the benefit that the information provided is very accurate and the content to be displayed can therefore be determined in a highly targeted manner with regard to time and location of the display. Since future motor vehicles will often have a data connection to a back-end, it is possible to provide the information by means of the navigation apparatus with little effort. Although deducing the information from the journey profile is less accurate, it is often sufficient for determining the content to be displayed. Furthermore, the motor vehicle does not require a data connection. Especially journeys between home and the workplace are typically made along the same route and at regular times.

In some embodiments, the navigation apparatus provides at least one of the following items of information on the route of travel of the motor vehicle: a planned route, a current position or information on at least one display device on the route of travel. The planned route allows direct determination of which display devices are passed at which times. Moreover, the travel destination can also be considered when determining the content to be displayed. For example, in the case of a journey to a vacation destination, information on events or particular places at the destination, such as restaurants or shops, can be given along the route of travel. Conclusions on the route of travel can also be drawn from the current position or temporal succession of positions received, which conclusions can be used to determine on which display device and at which time the content should be displayed. At the same time, the motor vehicle transmits less sensitive data. If the locations of display devices are known to the motor vehicle or a back-end of the manufacturer of the motor vehicle, it is also sufficient for the purpose of implementing the solution merely to transmit information on the display device on which and, if applicable, the time at which a display should take place. In this way, the amount of data to be transmitted is further reduced.

In some embodiments, information on a viewing direction of the occupant of a motor vehicle is received. In the future, cameras for monitoring the driver or the passenger compartment will increasingly be installed in motor vehicles. By means of these cameras, viewing directions of the motor vehicle occupants can be determined. The information on the viewing directions can be used for a variety of purposes. For example, using the information received on the viewing direction of the occupant of the motor vehicle, a specific display device for displaying the content to be displayed can be designated. It is often the case that a plurality of display devices are arranged one next to the other at the side of a road. Using the information on the viewing direction, it is possible in such a case to determine which of the adjacent display devices the occupant actually looks at, such that the display can take place on this particular display device. The information on the viewing direction can also be evaluated statistically. It is therefore possible, for example, to determine which display devices a vehicle occupant usually looks at along a route generally traveled.

According to some embodiments, based on the information received on the viewing direction of the occupant of the motor vehicle, the relevance of the displayed content or display device to the occupant of the motor vehicle can be determined. The information on the viewing direction can be matched with external knowledge on locations of display devices in order to make a statement on how likely it is that and for how long a vehicle occupant has actually looked at the corresponding display device or displayed content. The information gained from a large number of vehicles equipped with this technology can be stored and evaluated in a back-end, for example in an anonymized manner. In this way, comprehensive statistics on the relevance of specific display devices and content can be produced.

According to another aspect of the invention, a motor vehicle comprising a navigation apparatus and a device for monitoring an occupant is designed to provide information on a route of travel or on a viewing direction of the occupant to a device for providing content for display to the occupant of the motor vehicle. A motor vehicle designed in this way is ideally suitable for use in conjunction with the method and/or device described.

Further features of the present invention will become apparent from the following description and the appended claims in conjunction with the FIGS.

In order to better understand the principles of the present invention, further embodiments are explained in greater detail in the following based on the FIGS. It should be understood that the invention is not limited to these embodiments and that the features described can also be combined or modified without departing from the scope of protection of the invention as defined in the appended claims.

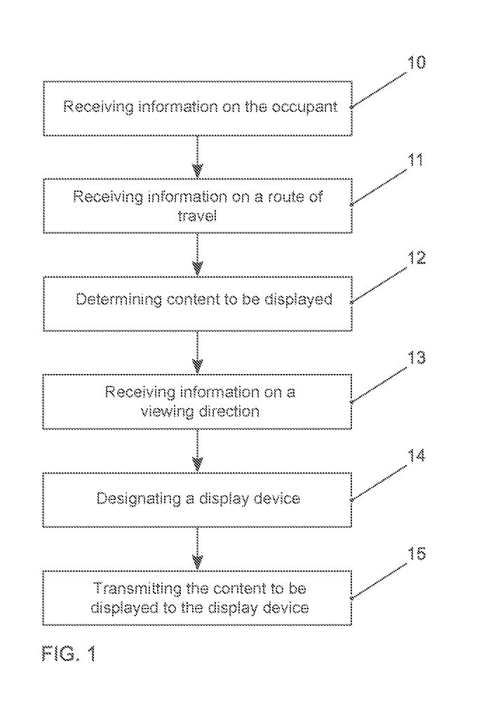

FIG. 1 schematically shows a method for providing content for display to an occupant of a motor vehicle. In a first step, information on the occupant is received 10. In addition, information on a route of travel of the motor vehicle is received 11. This can for example be provided by a navigation apparatus of the motor vehicle or deduced from a journey profile of the motor vehicle or occupant of the motor vehicle. For example, the navigation apparatus can provide information on a planned route or on a current position of the motor vehicle. However, the navigation apparatus can also provide information on a relevant point along the route of travel, for example information on a display device that will be passed by the motor vehicle at a later time. For example, the information also comprises time information, for example the estimated time at which the display device will be passed. On the basis of the information received, content to be displayed to the occupant is then determined 12. In doing so, information on two or more occupants and the routes of travel of two or more motor vehicles may also be taken into consideration. Optionally, information on a viewing direction of the occupant of the motor vehicle can also be received 13. This information on the viewing direction can be used to designate 14 a display device for displaying the content to be displayed. This is practical in particular if there is potentially a plurality of display devices eligible for the display. Finally, the content to be displayed is transmitted 15 to at least one display device on the route of travel of the motor vehicle. In addition, the relevance of the displayed content or of the display device to the occupant of the motor vehicle can be determined on the basis of the information on the viewing direction.

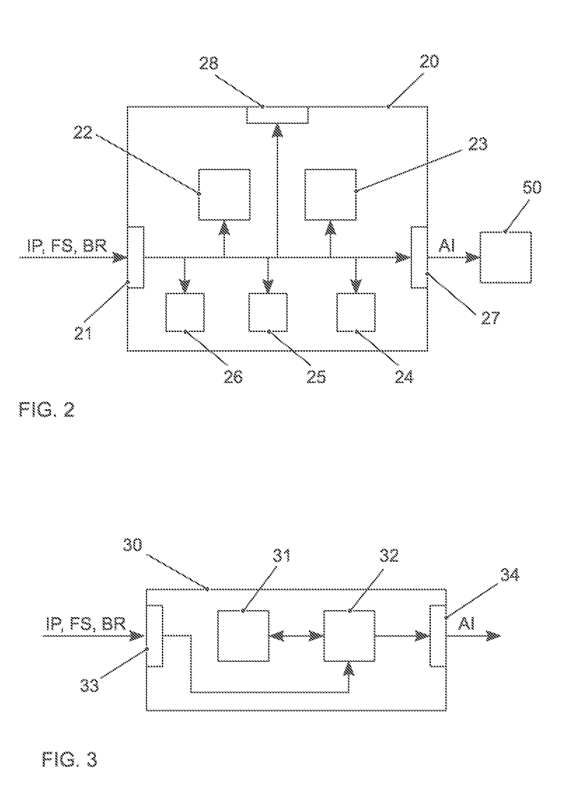

FIG. 2 is a simplified schematic representation of a first embodiment of a device 20 for providing content for display to an occupant of a motor vehicle. The device 20 comprises an input 21, via which information on the occupant IP and information on a route of travel FS of the motor vehicle, for example, can be received by means of a reception module 22. The information on the route of travel can for example be provided by a navigation apparatus of the motor vehicle or deduced from a journey profile of the motor vehicle or occupant of the motor vehicle. For example, the navigation apparatus can provide information on a planned route or on a current position of the motor vehicle. However, the navigation apparatus can also provide information on a relevant point along the route of travel, for example information on a display device that will be passed by the motor vehicle. For example, the information also may comprise time information, e.g., the estimated time at which the display device will be passed. The device 20 additionally comprises an evaluation module 23 for determining content to be displayed to the occupant. In doing so, the evaluation module 23 may also take information on two or more occupants IP and the routes of travel FS of two or more motor vehicles into consideration. Optionally, information on a viewing direction BR of the occupant of the motor vehicle can also be received. This information on the viewing direction BR can be used by the evaluation module 23 to designate a display device for displaying the content to be displayed. A transmission module 24 transmits the content to be displayed AI to at least one display device 50 on the route of travel of the motor vehicle via an output 27 of the device 20. In addition, the evaluation module 23 can also determine the relevance of the displayed content or of the display device to the occupant of the motor vehicle on the basis of the information on the viewing direction BR.

The reception module 22, the evaluation module 23 and the transmission module 24 can be controlled by a control unit 25. If necessary, settings of the reception module 22, evaluation module 23, transmission module 24, or control unit 25 can be changed by means of a user interface 28. The data accumulating in the device 20 can be filed in a memory 26 of the device 20 if required, for example for later evaluation or for use by the components of the device 20. The content to be displayed can also be held in the memory 26. The reception module 22, evaluation module 23, transmission module 24, and control unit 25 can be realized as dedicated hardware, such as integrated circuits. Of course, they can, however, also be partially or completely combined or implemented as software that runs on a suitable processor, such as a GPU or CPU. The input 21 and output 27 can be implemented as separate interfaces or as a combined bidirectional interface.

FIG. 3 is a simplified schematic representation of a second embodiment of a device 30 for providing content for display to an occupant of a motor vehicle. The device 30 comprises a processor 32 and a memory 31. For example, the device 30 is a computer or controller. Instructions are saved in the memory 31 that, when executed by the processor 32, cause the device 30 to execute the steps according to one of the described methods. The instructions saved in the memory 31 thus represent a program that can be run by the processor 32 and that is realized by the method according to the present aspect. The device 30 comprises an input 33 for receiving information, in particular information on the occupant IP, a route of travel FS of the motor vehicle, and a viewing direction BR of the occupant. Data generated by the processor 32, in particular data relating to the content to be displayed AI, are made available via an output 34. Moreover, said data can be saved in the memory 31. The input 33 and the output 34 can be combined into a bidirectional interface.

The processor 32 can comprise one or more processor units, for example microprocessors, digital signal processors or combinations thereof.

The memories 26, 31 of the described embodiments can have volatile as well as non-volatile memory sections and can comprise a wide range of memory units and storage media, such as hard disks, optical storage media or semiconductor memories.

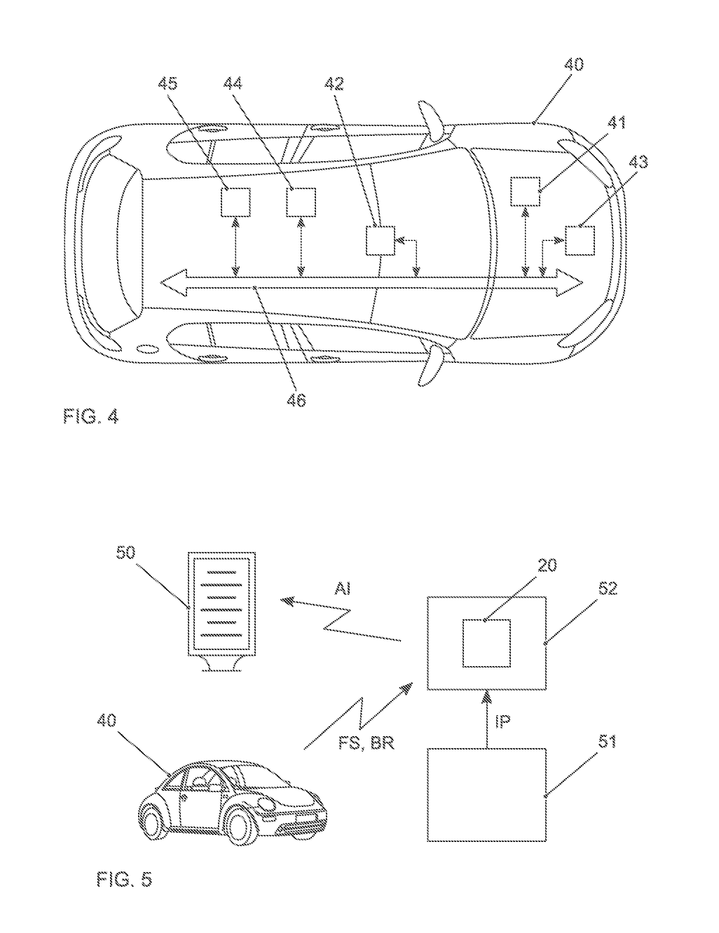

FIG. 4 schematically shows a motor vehicle 40 in which a solution according to the present embodiment is realized. The motor vehicle comprises a navigation apparatus 41 which is configured to provide information on a route of travel of the motor vehicle 40. In this case, said information may for example be information on a planned route or a current position of the motor vehicle 40. The information on the route of travel may also consist of information on a relevant point along the route of travel, for example information on a display device that will be passed by the motor vehicle. For example, the information also may comprise time information, for example the estimated time at which the display device will be passed. Moreover, a camera 42 for passenger compartment monitoring is provided, by means of which a viewing direction of at least one vehicle occupant, inter alia, can be determined. Further components of the motor vehicle 40 are a surround sensor system 43 for detecting the surroundings and a data transmission unit 44. By means of the data transmission unit 44, a connection to service providers can be established, for example for transmitting information on the route of travel or viewing direction of the vehicle occupant. A memory 45 is provided for storing data. The data is exchanged between the various components of the motor vehicle 40 via a network 46.

FIG. 5 schematically shows a system diagram of a first implementation of the solution according to the present embodiment. In this implementation, only information on an occupant IP of the motor vehicle 40 is transmitted by a back-end 51 of the vehicle manufacturer to a back-end 52 of an operator of a display device 50. Information on the route of travel FS of the motor vehicle 40 and optionally information on the viewing direction BR of the vehicle occupant is transmitted directly from the motor vehicle 40 to the back-end 52 of the operator of the display device 50. In this back-end, the received information IP, FS, BR is processed by a device 20 for providing content in order to determine the content to be displayed AI. If necessary, the information is statistically evaluated. The content to be displayed is then transmitted from the back-end 52 to the display device 50 via a wireless or wired data connection. A benefit of this implementation is that only small amounts of data have to be provided by the back-end 51 of the vehicle manufacturer.

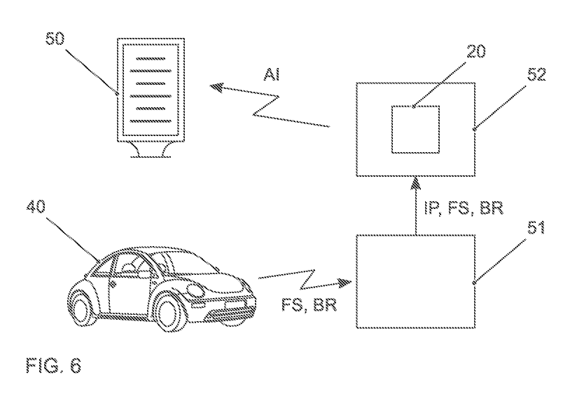

FIG. 6 schematically shows a system diagram of a second implementation of the solution according to the present embodiment. In this implementation, the information on the route of travel FS of the motor vehicle 40 and optionally the information on the viewing direction BR of the vehicle occupant is transmitted from the motor vehicle 40 to the back-end 51 of the vehicle manufacturer. The information on the occupant IP of the motor vehicle 40 and information on the route of travel FS and on the viewing direction BR is then transmitted by the back-end 51 of the vehicle manufacturer to the back-end 52 of the operator of the display device 50. There, the received information IP, FS, BR is processed as usual in order to determine the content to be displayed AI and to transmit same to the display device 50. A benefit of this implementation is that all information can be transmitted to the back-end 52 of the operator of the display device 50 in anonymized form.

### REFERENCE NUMBER LIST

10 Receiving information on the occupant
11 Receiving information on a route of travel
12 Determining content to be displayed
13 Receiving information on a viewing direction
14 Designating a display device
15 Transmitting the content to be displayed to the display device
20 Device
21 Input
22 Reception module
23 Evaluation module
24 Transmission module
25 Control unit
26 Memory
27 Output
28 User interface
30 Device
31 Memory
32 Processor
33 Input
34 Output
40 Motor vehicle
41 Navigation apparatus
42 Camera
43 Surround sensor system
44 Data transmission unit
45 Memory
46 Network
50 Display device
51 Back-end of the vehicle manufacturer
52 Back-end of the operator of the display device
AI Content to be displayed
BR Information on the viewing direction
FS Information on the route of travel
IP Information on the occupant

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measured cannot be used to advantage. Any reference signs in the claims should not be construed as limiting the scope.

What is claimed is:

1. A method for providing content for display to an occupant of a motor vehicle, comprising the following steps:
receiving information on the occupant;
receiving information on a route of travel of the motor vehicle;
determining content to be displayed to the occupant; and
transmitting the content to be displayed to at least one display device on the route of travel of the motor vehicle.

2. The method according to claim 1, wherein the content to be displayed is determined on the basis of information on two or more occupants.

3. The method according to claim 1, wherein the content to be displayed is determined on the basis of information on routes of travel of two or more motor vehicles.

4. The method according to claim 1, wherein the information on the route of travel of the motor vehicle is provided by a navigation apparatus of the motor vehicle or deduced from a journey profile of the motor vehicle or occupant of the motor vehicle.

5. The method according to claim 4, wherein the navigation apparatus provides at least one of the following items of information on the route of travel of the motor vehicle: a planned route, a current position or information on at least one display device on the route of travel.

6. The method according to claim 1, wherein information on a viewing direction of the occupant of the motor vehicle is received.

7. The method according to claim 6, wherein, using the information received on the viewing direction of the occupant of the motor vehicle, a display device for displaying the content to be displayed is determined.

8. The method according to claim 6, wherein, based on the information received on the viewing direction of the occupant of the motor vehicle, a relevance of the displayed content or of the display device to the occupant of the motor vehicle is determined.

9. A non-transitory computer-readable storage medium comprising instructions that, when executed by a computer, cause the computer to execute the steps of a method according to claim for providing content for display to an occupant of a motor vehicle.

10. A device for providing content for display to an occupant of a motor vehicle, comprising:
a reception module for receiving information on the occupant and for receiving information on a route of travel of the motor vehicle;
an evaluation module for determining content to be displayed to the occupant; and
a transmission module for transmitting the content to be displayed to at least one display device on the route of travel of the motor vehicle.

11. A motor vehicle comprising a navigation apparatus and a device for monitoring an occupant, wherein the motor vehicle is configured to provide information on a route of travel or a viewing direction of the occupant to a device for providing content for display to the occupant of the motor vehicle.

12. The method according to claim 2, wherein the content to be displayed is determined on the basis of information on routes of travel of two or more motor vehicles.
